(19) United States
(12) Patent Application Publication
(10) Pub. No.: US 2019/0307117 A1
(43) Pub. Date: Oct. 10, 2019

(54) AVIAN COLLISION AVOIDANCE SYSTEM AND METHOD

(71) Applicant: EDM INTERNATIONAL, INC., Fort Collins, CO (US)

(72) Inventors: James F. Dwyer, Fort Collins, CO (US); Arun K. Pandey, Fort Collins, CO (US); Andrew H. Stewart, Fort Collins, CO (US)

(21) Appl. No.: 16/378,810

(22) Filed: Apr. 9, 2019

Related U.S. Application Data
(60) Provisional application No. 62/655,305, filed on Apr. 10, 2018.

(51) Int. Cl. A01M 29/10; A01M 29/08; F03D 80/10

(52) U.S. Cl. CPC A01M 29/10; F03D 80/10; A01M 29/08

(57) ABSTRACT

An avian collision avoidance system utilizing a lighting system and a power source. The lighting system is able to focus on a power line, or power lines, or other structure such as a wind turbine or cell tower, to provide illumination visible to avian populations. The power source may generate power by any means necessary, may store power and may supply power to the lighting system. The lighting system will provide a light source in a desired wavelength to accommodate both humans and birds as necessary.

### CROSS-REFERENCE TO RELATED APPLICATION

This Non-Provisional patent application claims the benefit of the Provisional U.S. Patent Application No. 62/655,305, entitled “Avian Collision Avoidance System and Method,” filed with the U.S. Patent & Trademark Office on Apr. 10, 2018, which is specifically incorporated herein by reference for all that it discloses and teaches.

### BACKGROUND OF THE INVENTION

Collisions with power lines, and other structures that may include wind turbines or cell towers, are an important mortality factor among several bird species and taxonomic groups. The cumulative impact of mortality across a species' range may be significant. That mortality from power lines may be a potentially important limiting factor among endangered species. Successful recovery of the endangered whooping crane, as well as other types of birds, whether endangered or not, is dependent in part on development of protective measures to reduce collisions with power lines. Because of similarities in body size and flight characteristics, sandhill cranes often are used as surrogates or correlative models to assess potential impacts of various factors on whooping cranes. Despite heightened public awareness and a clear need to reduce power line mortality, few studies have been conducted to examine mortality among crane species.

In the United States, most studies of bird collisions have occurred since the late 1970s. These studies described the problem and have led to a growing awareness among stakeholders. For example, APLIC published its first Collision Manual in 1994 to summarize the knowledge of bird collisions with power lines at that time. National and international research on bird/power line interactions has since grown. Research today includes studies on collision reduction, monitoring systems, and standardization of collision mortality data collection. Future priorities include improving the comparability of studies, testing and documenting line marker efficacy, and refining remote collision detection devices. As power line infrastructure expands to meet the growing demand for electricity, the collision risk to avian species also seems likely to increase. Yet, this risk may be reduced by assessing potential avian impacts during line siting and routing, improving line marking devices, standardizing study methods, and increasing awareness.

In the United States, three federal laws protect almost all native avian species and prohibit taking (killing or injuring) them even if the act was unintended and occurred as a result of otherwise legal activities. The Migratory Bird Treaty Act (16 U.S.C. 703-712) protects 1,007 (2012) North American migratory bird species (50 CFR 10.13). The Bald and Golden Eagle Protection Act (16 U.S.C. 668-668c) provides additional protection for these two species. The Endangered Species Act (16 U.S.C. 1531-1555) provides protection to federally listed species (designated as threatened or endangered) and to their critical habitat. Utilities in the United States should work with both the U.S. Fish and Wildlife Service (USFWS) and state wildlife agencies to identify permits and procedures that may be required. In Canada, two laws protect avian species by prohibiting take. The Migratory Birds Convention Act protects most species of migratory birds in Canada. The Canadian Species at Risk Act provides for the protection and recovery of threatened and endangered species. Additional protection for species at risk has been developed by the provincial governments, such as the Alberta Wildlife Act. Utilities in Canada should work with the Canadian Wildlife Service and provincial wildlife agencies to identify permits and procedures that may be required. Similar laws exist in the European Union and in other countries.

Since 1994, line marking devices have been further developed in North America, Europe, and South Africa. Advances in aerial marker spheres, spirals, and suspended devices include changes to design, colors, attachments, and materials in an effort to improve effectiveness and durability and to reduce possible damage to lines.

### SUMMARY OF THE INVENTION

An embodiment of the invention may therefore comprise a system for avoiding avian collisions with a structure, wherein the system comprises a light system positioned to illuminate the structure with a wavelength of light visible to a specified avian population, a power supply enabled to provide power to the light system during low natural light periods, a connector that connects the light system to the power supply.

An embodiment of the invention may further comprise a method of illuminating a structure to avoid avian collisions, the method comprising positioning a light source capable of providing a wavelength of light visible to a pre-determined avian population so that the light source illuminates the structure, focusing light illuminated from the light source onto the structure, connecting the light source to a power supply.

### BRIEF DESCRIPTION OF THE DRAWINGS

FIG. 1 shows elements of an embodiment of the invention of an avian collision avoidance system.

FIG. 2 shows elements of an embodiment of the invention of an avian collision avoidance system with a power line segment.

FIG. 3 shows elements of an embodiment of the invention of an avian collision avoidance system placed on a power line segment.

### DETAILED DESCRIPTION OF THE EMBODIMENTS

Embodiments of the invention are directed toward a new and useful system and method of improving power line visibility for birds. It is understood that systems and methods taught in this specification are pertinent toward non-powerline structures. For instance, systems and methods of embodiments of the invention may be utilized in connection with wind turbines. Systems and methods of the invention may be utilized during low light conditions. Other structures may also be relevant to embodiments of the invention. Any structure that may be in the path of the flight of a bird, or several birds, may be relevant to embodiments of the invention. Further, while discussions in the specification may revolve around a particular type of bird, such as a whooping crane, embodiments of the invention are not limited to any particular bird, whether endangered or not.

Further, embodiments of the invention may comprise reference markers which incorporate UV lights, as opposed to being illuminated. Throughout the description of embodiments of the invention, a light system may be used to illuminate power lines and other structures. However, any type of illumination for providing a visible “warning” sign to birds is applicable. Embodiments of the invention may include the application of “light ropes” incorporating UV LEDs between power poles or on structures. Embodiments of the invention may include devices that will promote UV emissions (i.e., corona) on EHV power lines. Further, illumination of power lines and other structures may be achieved by applying phosphors that emit in the UV spectrum to components and structures.

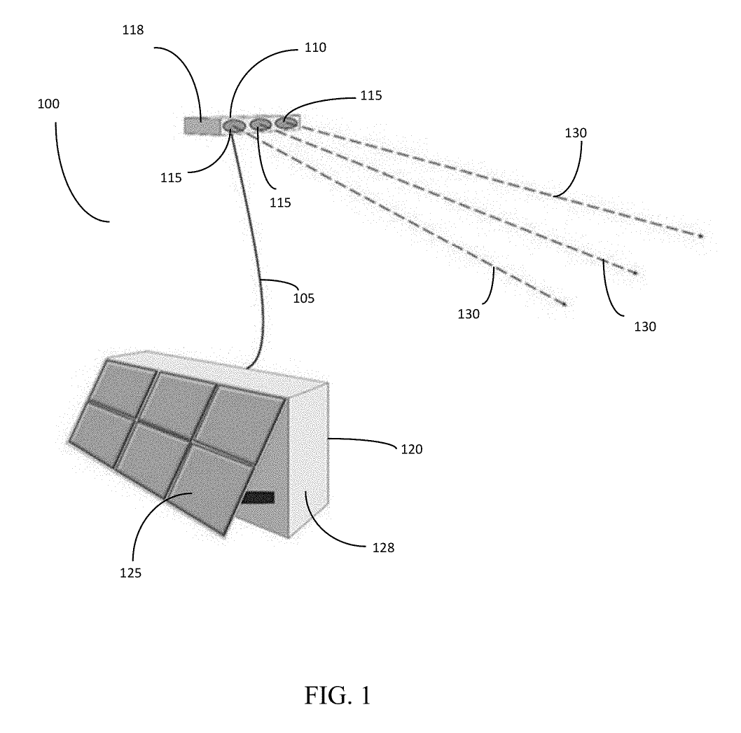

FIG. 1 shows elements of an embodiment of the invention of an avian collision avoidance system. An avian collision avoidance system 100 may comprise a light system 110 connected to a power supply 120 via a power connection 105. The light system 110 may be a plurality of LED (light emitting diode) lights. The light system 110 may be a laser light system. Any type of lighting may be used in the light system 110 which enables a user to supply a particular light wavelength. A light wavelength that is not visible to humans may generally be used. It is understood by those skilled in the art that human vision may allow for some people to view different wavelengths. For instance, a particular wavelength of light may be visible to one person while that same wavelength of light may not be visible to another person. Accordingly, it is understood that when discussing wavelengths of light, generalizations are made regarding visibility. While most persons may not find ultra-violet light visible, some may. As such, a wavelength of light that is generally not visible to people may be used, but some people may be able to see it. Moreover, a particular wavelength of light may be used that may be seen by a majority of people, but which may be more visible to birds. In such instances, the use of such a wavelength may be used to increase the visibility of a structure to a bird at the expense of allowing visibility to people. Each situation may be a case by case basis.

Such a light wavelength may be visible to birds when such a light is reflected off a power line or a line marker installed on a power line. Those skilled in the art will understand different types of lighting systems that allow particular frequencies of light to be emitted. The beams of light from the emitters 115 are indicated by dotted lines 130.

The light system 110 shown in FIG. 1 shows three emitters 115. There may be fewer or more than three emitters. For instance, the light system 110 may comprise four emitters. Each emitter 115 may emit the same wavelength light as the other emitters 115. Each of the emitter 115 may also emit a different wavelength light. Emitting a different wavelength light from each emitter allows a degree of variance in the light that may be visible to birds and may allow for different environmental conditions. The light of the emitters 115 may also be variable within a set spectrum. A user may be able to adjust the wavelength of light from an emitter 115 based on feedback. Such feedback may comprise observations and testing to ensure the efficacy of installed light systems 110. A user may be able to adjust the duration of the light from continuous to pulsed.

A junction box 118 is shown as part of the light system 110. The junction box 118 splits power from the power supply. Accordingly, each emitter 115 receives a consistent power.

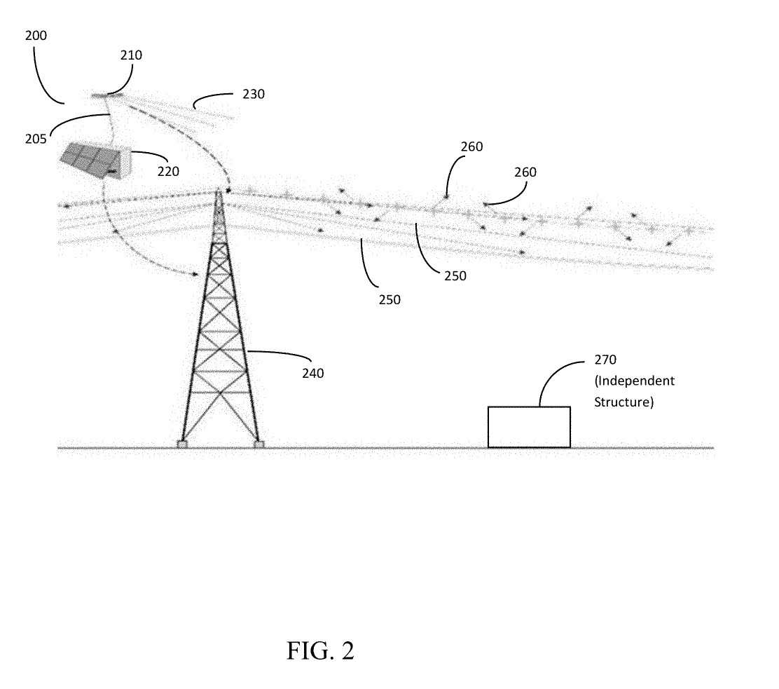

The power supply 120 may comprise any type of power supply that enables a consistent power to the light system 110. The power supply 120 may be a battery box 128. The battery box 128 may receive power from a solar panel 125 connected to the battery box 128. The battery box 128 may also receive power from a generator (not shown). The battery box 128 may also harvest power from a pole (element 240 in FIG. 2). Those skilled in the art will understand harvesting power from an existing power line to power a separate device. Any type of power supply is acceptable. A battery box 128 is used because the power to the light system 110 is primarily operated during low light conditions. Accordingly, a solar panel 125 as shown in FIG. 1 may not be able to provide power during primary usage times. The power supply 120 may also supply power directly to the light system 110. The power supply may harvest power from the power lines (for example) directly to the light system. Those skilled in the art will understand how to supply power directly to the light system 110. A battery box may be enclosed in a vault.

The light system 110 is connected to the power supply 120 by means of an electrical connection. Those skilled in the art will understand how to connect a power supply to a device that uses the power.

FIG. 2 shows elements of an embodiment of the invention of an avian collision avoidance system with a power line segment. The avian collision avoidance system 200 may comprise a light system 210 connected to a power supply 220 by means of a power connection 205. The power supply 220 is attached to a power line pole 240. The power supply 220 may be attached to any location on the power line pole 240. The power supply may be attached to a lower location on the power line pole 240. A lower attachment location may provide easier access to the power supply 220 in the event that service is required. The power supply 220 may be attached to any location on the power line pole 230. A user may determine that a higher location provides better power harvesting, safety from ground elements, or illumination of power lines.

The light system 210 may be attached to the upper portion of the power line pole 240. The light emitted from the light system 210 is indicated by dotted lines 230. The light system 210 shines a light toward the power lines 250. The power lines will reflect the light 260. As shown in FIG. 2, an attachment of the light system 210 to an upper location allows the light system 210 to shine a light of a desired wavelength somewhat downwardly toward the power lines 250. The light system 210 may be attached anywhere on the power line pole 240 that allows the light system 210 to illuminate the power lines 250. The light system 210 may be attached to a structure 270 independent of the power line pole 240. The light system 210 attached to a structure 270 would be able to illuminate the power lines 250 from below. The illumination 230 would reflect 260 off the power lines 250 or line markers attached to power lines to be visible to birds. It is understood that the structure 270 may be anything that allows for fixation of the light system 210. The structure 270 may range from a cement construction to a stick in the ground. The structure 270 may be one that is fixed, unmovable, or one that is moveable. One skilled in the art will understand the different types of structures that will allow a light system 210 to be attached and remain positioned to illuminate the power lines.

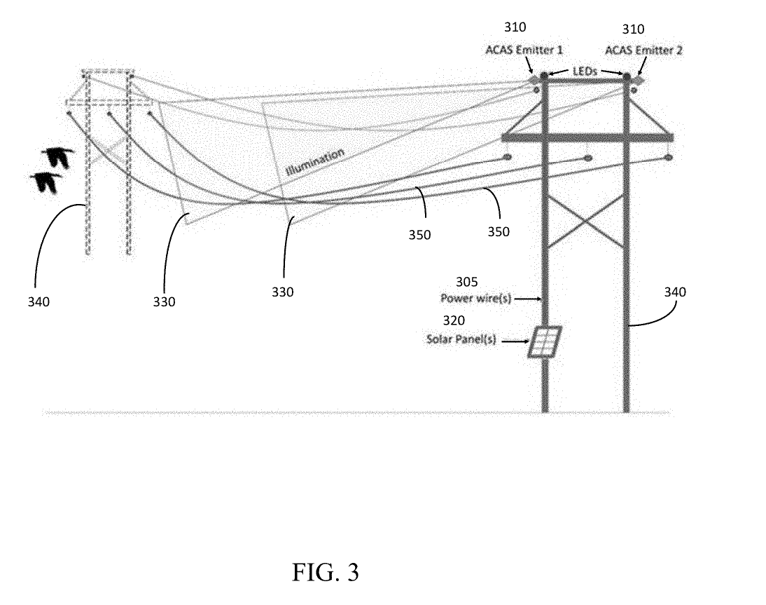

FIG. 3 shows elements of an embodiment of the invention of an avian collision avoidance system placed on a power line segment. An avian collision avoidance system may comprise a light system 310 attached to a power line pole 340. A series of power lines 350 are connected between power line poles 340. Two light systems 310 are shown in FIG. 3. One light system 310 may be used. Two, three, four, or more, light systems may be used. The use of multiple light systems allows for redundancy in the event that a light system 310 fails. The light system 310 provides illumination 330 onto the power lines 350. The light system 310 is connected via a power connection 305 to a power supply 320. A power supply 320 (such as a battery box powered by a solar panel as shown in FIG. 3) enables a consistent power to the light system 310. As noted above, the power source may be any power source. A generator may be used to provide power to a battery box or directly to the light system. Power may be harvested from the power lines 350 to provide power to the battery box or directly to the light system 310.

The light system 310 may be focused on the power lines 350. For instance, the light system 310 may provide a 30-degree cone of illumination 330 toward the power lines. The cone of illumination 330 may be more focused or less focused depending on the environment and the layout of the power line poles. For instance, the cone of illumination 330 may need a more restricted cone (20 degrees for instance) to provide illumination to a tighter array of power lines 350. Different degrees of illumination may provide for providing illumination at a further, or shorter, distance as well. It is understood that the circumstances of each individual light system may be adjusted to circumstances.

The wavelength of the illumination 330 may be primarily ultra-violet light. Ultra-violet light may be mostly, if not entirely, not visible to people. However, birds of interest may be able to see the ultra-violet light. A part of the illumination 330 may be visible. For instance, a portion of the visible light may be purple. A visible purple light will enable a visible inspection to ensure that the light is on. Other light wavelengths may be used to provide visible indications to a human observer without being unacceptable during evening hours. The wavelength of the illumination 330 may also be other than ultra-violet. Also, the wavelength may be fine-tuned to user preference.

As shown in FIG. 3, a light system 310 is only shown on one of the power line poles 340. It is understood that the power lines 350 may be illuminated from both directions. Accordingly, both power line poles 340 may have an attached light system 310 and power supply that illuminates power lines 350 in both directions. Further, a light system 310 may also be provided that is not attached to the power line poles 340. As such, power lines 350 may be illuminated from both directions (from both power line poles 340) and from a ground structure (not shown in FIG. 3). One or more, in combination, of the possible illumination sites may be used. The light system 310 may comprise an optical lens for each emitter. The optical lens provides the ability to focus the illumination 330 as desired.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A system for avoiding avian collisions with a structure, wherein said system comprises:
a light system positioned to illuminate said structure with a wavelength of light visible to a specified avian population;
a power supply enabled to provide power to said light system during low natural light periods;
a connector that connects said light system to said power supply.

2. The system of claim 1, wherein said structure is a power line supported by at least one power line pole.

3. The system of claim 2, wherein said light system is connected to said power line pole.

4. The system of claim 2, wherein said light system comprises a plurality of light emitters and a junction box that supplies power to said light emitters.

5. The system of claim 3, wherein each light emitter comprises an optical lens, said emitters located so as to be focusable with said lens toward said power line.

6. The system of claim 3, wherein each of said plurality of emitters emits a light wavelength specified by a user.

7. The system of claim 2, wherein said power supply comprises a power generation device and a power storage device.

8. The system of claim 7, wherein said power generation device is at least one solar panel.

9. The system of claim 7, wherein said power generation device is a power harvester that harvests power from said power line.

10. The system of claim 7, wherein said power storage is at least one battery.

11. The system of claim 2, wherein said light system is connected to a structure independent of said power line pole.

12. A method of illuminating a structure to avoid avian collisions, said method comprising:
positioning a light source capable of providing a wavelength of light visible to a pre-determined avian population so that said light source illuminates said structure;
focusing light illuminated from said light source onto said structure;
connecting said light source to a power supply.

13. The method of claim 12, wherein said structure is a power line, said power line being supported by at least one power line pole.

14. The method of claim 12, wherein said method of positioning a light source comprises attaching said light source to a position on a power line pole.

15. The method of claim 12, wherein said position on a power line pole is at the top of said power line pole.

16. The method of claim 12, wherein said power supply comprises a power generation device and a power storage device.

17. The method of claim 16, wherein said power generation device comprises at least one solar panel.

18. The method of claim 12, wherein said light source comprises a plurality of light emitters and a junction box that supplies equal power to said light emitters.

19. The method of claim 12, wherein each light emitter comprises an optical lens, said emitters located so as to be focusable with said lens toward said power line.

20. The method of claim 12, wherein said method of positioning a light source comprises attaching said light source to a structure independent of a power line pole.
